(19) United States
(12) Patent Application Publication
(10) Pub. No.: US 2015/0282020 A1
(43) Pub. Date: Oct. 1, 2015

(54) MECHANISM FOR CONTROLLING A COMMUNICATION BY TERMINAL DEVICE

(71) Applicant: NOKIA SOLUTIONS AND NETWORKS OY, Espoo (FI)

(72) Inventors: Kari Pekka Pajukoski, Oulu (FI); Kari Juhani Hooli, Oulu (FI); Esa Tapani Tiirola, Kempele (FI); Eeva Lahetkangas, Oulu (FI); Ilkka Harjula, Oulu (FI)

(21) Appl. No.: 14/438,420

(22) PCT Filed: Oct. 25, 2012
(86) PCT No.: PCT/EP2012/071104

§ 371 Date: Apr. 24, 2015

(51) Int. Cl. H04W 36/00; H04W 28/26; H04W 72/04

(52) U.S. Cl. CPC H04W 36/0072; H04W 72/048; H04W 72/0413; H04W 28/26; H04W 88/02

(57) ABSTRACT

There is provided a mechanism for controlling a procedure for requesting resources for a communication in a communication network by a terminal device or UE. When the UE has selected a target cell from a plurality of communication cells, a message such as a resource request. A controller of a cell, such as an eNB, scans the reserved resources for receiving a message such as the resource request from a UE. The message is decoded by using identification information of the own cell and identification information of UEs being valid in the own cell. Then, it is determined whether the received message indicates as the target cell the own cell, and whether the UE is a known UE allocated to the own cell. Based on this determination, the message such as the resource request is processed or another cell is informed thereabout.

### BACKGROUND OF THE INVENTION

### Field of the Invention

The present invention relates to a mechanism for controlling a communication in a communication network by a terminal device or user equipment. Specifically, the present invention is related to an apparatus, a method and a computer program product which allow, for example, that a terminal device or user equipment requests autonomously resources for a communication from a target cell, for example in case of an autonomous cell selection procedure. Examples of embodiments of the invention are in particular applicable in heterogeneous network structures comprising, for example, plural small cells (e.g. local area cells).

The following meanings for the abbreviations used in this specification apply:
BS: base station
CG: computer generated
CPU: central processing unit
C-RNTI: cell radio network temporary identity
DL: downlink
eNB: evolved node B
eRAB: EUTRAN radio access bearer
EUTRAN: evolved universal mobile telecommunication system terrestrial radio access network
ID: identification, identifier
HO: handover
LA: local area
LB: long block
LTE: Long Term Evolution
LTE-A: LTE Advanced
PCell: primary cell
PCI: physical cell ID
PRB: physical resource block
PUCCH: physical uplink control channel
PUSCH: physical uplink shared channel
QoS: quality of service
RACH: random access channel
RRC: radio resource control
SCell: secondary cell
TA: time advance
TDD: time division duplex
UE: user equipment
UL: uplink

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) and fourth generation (4G) communication networks like the Universal Mobile Telecommunications System (UMTS), enhanced communication networks based e.g. on LTE or LTE-A, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Generally, for properly establishing and handling a communication connection between terminal devices such as a user equipment (UE) and another communication network element or user equipment, a database, a server, etc., one or more intermediate network elements such as communication network control elements, such as base stations, control nodes, support nodes or service nodes are involved which may belong to different communication network.

In order to enhance performance of communication networks, the implementation of heterogeneous network structure is considered. A heterogeneous network consists of e.g. a “normal” communication cell (also referred to as macro cell) controlled by a communication network control element, such as an eNB in LTE networks, and plural small cells having also an own communication network control element, which are referred to, for example, as local area (LA) cells controlled by a corresponding LA node. A heterogeneous network provides, for example, an improved coverage and the possibility for outsourcing from a communication in the macro cell to a small cell. The LA cells are connected, for example, to the communication network control element of the macro call by a backhaul network offering high capacity, or the like. A macro cell is used, for example, as a primary cell (PCell) for a UE communication, and the LA cells are used as secondary cells (SCells) for the UE communication.

When a UE is communicating in a communication network with plural cells (one or more macro cells, plural local cells, for example), one or more cells are selected with which the UE communicates. For example, in an LTE based network, the used cell selection method depends on a state of the UE state (idle state or RRC connected state, for example). For example, a UE autonomous cell selection is used when the UE is in idle state whereas a network controlled mode is used when the UE is in RRC connected state. The network controlled mode involves a HO procedure which requires a high signaling amount on several interfaces between network nodes and the UE.

When now considering a deployment case of a heterogeneous network with plural LA cells, for example, the HO procedure is more complicated. Generally, LA cells are rather small compared to a usual macro cell, e.g. in the order of several tenths to 150 meters in diameter, or the like. Furthermore, it is possible that LA cells are densely packed, i.e. that there are many LA cells in a relatively small area, wherein a UE us able to detect plural LA cells at the same time. Hence, in such dense LA cell cases, the UE needs to measure and report on many cells, which in turn causes a high amount of RRC signaling over the full network area. Furthermore, the small LA cells have only a limited (i.e. small) coverage area so that they are “visible” (i.e. in range) for moving users for a rather short time-instant. Hence, in dense LA cell cases, a UE may pass through multiple cells with changing properties so that a cell being at one moment a preferred target cell may be replaces by another cell before even completing a connection thereto, for example. Consequently, a cell selection based on the conventional connected mode used e.g. in LTE is not optimal, for example in cases of a dense LA cell deployment, since a lot of time is required for measurement and reports which is to be subtracted from the rather short period of time where the moving UE is in range of the small cell, while at the same time a lot of signaling between the network and the UE is required which causes not only cause a delay but increases also the signaling load in the network.

### SUMMARY OF THE INVENTION

It is an object of the invention to overcome at least some of the above described problems and to provide an enhanced mechanism for controlling a communication in a communication network by a terminal device or UE. Specifically, it is an object of the present invention to provide an apparatus, a method and a computer program product which allow, for example, that a terminal device or UE requests autonomously resources for a communication from a target cell.

These objects are achieved by the measures defined in the attached claims.

According to an example of an embodiment of the proposed solution, there is provided, for example, an apparatus comprising at least one processor, at least one interface to at least one other network element, and at least one memory for storing instructions to be executed by the processor, wherein the at least one memory and the instructions are configured to, with the at least one processor, cause the apparatus at least to perform: a receiving function configured to receive a message, the message comprising information indicating an identity of a communication element and information indicating an identity of a communication cell as a target cell, a decoding processing function configured to conduct a decoding on transmissions for the message by using identification information of an own cell and identification information of communication elements being valid in the own cell, and a determining function configured to determine, on the basis of a result of the decoding, whether or not the target cell indicated in the message is the own cell, and whether or not the communication element identified in the message is a known communication element allocated to the own cell.

Furthermore, according to an example of an embodiment of the proposed solution, there is provided, for example, a method comprising receiving a message, the message comprising information indicating an identity of a communication element and information indicating an identity of a communication cell as a target cell, conducting a decoding on transmissions for the message by using identification information of an own cell and identification information of communication elements being valid in the own cell, and determining, on the basis of a result of the decoding, whether or not the target cell indicated in the message is the own cell, and whether or not the communication element identified in the message is a known communication element allocated to the own cell.

According to further refinements, these examples may comprise one or more of the following features:
the message may be processed on the basis of the result of the determining, wherein the processing may comprise, in case it is determined that the target cell indicated in the received message is the own cell and the communication element is a known communication element allocated to the own cell, deciding on an allocation of communication resources on the basis of information in the message, and causing sending of a response message to the received message indicating the decision on the resource allocation, in case it is determined that the target cell indicated in the received message is the own cell and the communication element is an unknown communication element, conducting a procedure for acquiring the identity of the communication element, and in case it is determined that the target cell indicated in the received message is not the own cell and the communication element is a known communication element allocated to the own cell, causing a transmission of a handover related signaling to a cell being the target cell indicated in the message for informing the target cell about the received message;
the message may be received via communication resources reserved for a transmission of the message; in this case, an indication of time and frequency resources reserved for the transmission of the message may be sent in the own cell, wherein the time and frequency resources reserved for the transmission of the message may be selected to be the same as time and frequency resources reserved for a transmission of the message in a neighboring cell of the own cell;
an indication may be received from a neighboring cell regarding a message received at the neighboring cell wherein the target cell indicated in the message is the own cell, and a decision may be done on an allocation of resources on the basis of the indication;
the information in the message indicating the identity of the requesting communication element may comprise one of a physical identification element being an allocated identifier of the communication element in the target cell in case the communication element is known to the target cell, a temporal identifier related to the communication element in case the communication element is unknown to the target cell, and a usage of dedicated resources for the transmission of the message, the dedicated resources being allowed only for communication elements known to the target cell, and the information in the message indicating the identity of the communication cell being the target cell may comprise a known physical identification element of the target cell;
the message may further comprise at least one of a sender identifier, a receiver identifier, and service related information indicating a requested quality of service for a data communication via requested resources;
the information indicating the identity of the communication element identified in the message and the information indicating the identity of the target cell may be coded by using a single codeword;
the information indicating the identity of the communication element and the information indicating the identity of the target cell may be conveyed in the message as dedicated sequences, wherein one sequence may be dedicated to the identity of the communication element and another sequence may be dedicated to the identity of the target cell, wherein further a correlation of the received message may be done by using sequences corresponding to the identification of the own cell and corresponding to the identification of communication elements being valid in the own cell;
the message may be received via communication resources reserved for the transmission of the message on at least one of a physical uplink shared channel, a physical uplink control channel, and a random access channel;
the message may comprise a resource request for requesting resources for data transmission in the target cell, in at least one of an initial access of the requesting communication element to the target cell, a scheduling request for a communication of the requesting communication element in the target cell, and a cell change of the requesting communication element to the target cell;
the above processing may be is implemented in a communication network control element controlling a primary cell or a secondary cell of a communication network in which the communication element can communicate, wherein the communication element may be a terminal device or user equipment.

According to another example of an embodiment of the proposed solution, there is provided, for example, an apparatus comprising at least one processor, at least one interface to at least one other network element, and at least one memory for storing instructions to be executed by the processor, wherein the at least one memory and the instructions are configured to, with the at least one processor, cause the apparatus at least to perform: a selection function configured to select at least one target cell from a plurality of communication cells with which a communication element can communicate, and a transmission function configured to prepare a message comprising information indicating an identity of a communication element and information indicating an identity of the communication cell selected as the target cell from, and to cause transmission of the message.

Furthermore, according to the other example of an embodiment of the proposed solution, there is provided, for example, a method comprising selecting at least one target cell from a plurality of communication cells with which a communication element can communicate, preparing a message comprising information indicating an identity of a communication element and information indicating an identity of the communication cell selected as the target cell, and causing transmission of the message.

According to further refinements, this other example may comprise one or more of the following features:
the message may be transmitted via communication resources reserved for a transmission of the message; in this case, an indication of time and frequency resources reserved for the transmission of the message may be received, wherein the time and frequency resources reserved for the transmission of the message may be the same in plural communication cells of the communication network;
the preparation of the message may further comprise using, in the message, as the information indicating the identity of the requesting communication element, one of a physical identification element being an allocated identifier of the communication element in the target cell in case the communication element is known to the selected target cell, a temporal identifier related to the communication element in case the communication element is unknown to the selected target cell, dedicated resources for the transmission of the message, the dedicated resources being allowed only for communication elements known to the selected target cell, and using in the message, as the information indicating the identity of the communication cell as being the target cell a known physical identification element of the target cell;
the message may further comprise at least one of a sender identifier, a receiver identifier, and service related information indicating a requested quality of service for a data communication via requested resources;
the information indicating the identity of the communication element identified in the message and the information indicating the identity of the target cell may be coded by using a single codeword;
the information indicating the identity of the communication element and the information indicating the identity of the target cell may be conveyed in the message as dedicated sequences, wherein one sequence may be dedicated to the identity of the communication element and another sequence may be dedicated to the identity of the target cell;
a transmission of the message may be done via communication resources reserved for the transmission of the message on at least one of a physical uplink shared channel, a physical uplink control channel, and a random access channel;
the message may comprise a resource request for requesting resources for data transmission in the target cell, in at least one of an initial access of the requesting communication element to the target cell, a scheduling request for a communication of the requesting communication element in the target cell, and a cell change of the requesting communication element to the target cell;
the above processing may be implemented in a communication element including at least one of a terminal device or user equipment, wherein the resource request may be transmitted to at least one communication network control element controlling a primary cell or a secondary cell of the communication network in which the communication element can communicate.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

By virtue of the proposed solutions, it is possible to provide an enhanced mechanism for controlling a communication in a communication network by a terminal device or UE. That is, it is possible to provide a mechanism allowing a terminal device or UE to request autonomously resources for a communication from a target cell, e.g. in case of an initial access, a scheduling procedure or a handover (selection of a new cell). For example, it is possible to conduct an optimized LA cell selection procedure, e.g. in an LTE-A communication system. In addition, the UE can autonomously select a cell independent of a specific UE state (idle or RRC connected, for example), so that a required measurement reporting from the UE to the network can be reduced. Moreover, it is possible by the proposed scheme to achieve a fast switching between cells, compared e.g. with existing RACH based switching procedures. Furthermore, the signaling burden compared e.g. to a network controlled handover procedure can be reduced. In addition, support for error protection is provided. In addition, the proposed scheme allows capitalizing characteristics features of an LA radio environment, for example by using the fact that TA is not needed when communicating with an LA cell, so that a simplified LA communication system is achievable.

The above and still further objects, features and advantages of the invention will become more apparent upon referring to the description and the accompanying drawings.

### BRIEF DESCRIPTION OF THE DRAWINGS

FIG. 1 shows a diagram illustrating a communication network configuration where some examples of embodiments of the invention are implemented.

FIG. 2 a flowchart illustrating a processing executed in a communication network control element according to some examples of embodiments of the invention.

FIG. 3 shows a flowchart illustrating a processing executed in a communication element according to some examples of embodiments of the invention.

FIG. 4 shows a diagram illustrating a slot structure for a request according to some examples of embodiments of the invention.

FIG. 5 shows a block circuit diagram of a communication network control element including processing portions conducting functions according to some examples of embodiments of the invention.

FIG. 6 shows a block circuit diagram of a communication element including processing portions conducting functions according to some examples of embodiments of the invention.

### DESCRIPTION OF PREFERRED EMBODIMENTS

In the following, examples and embodiments of the present invention are described with reference to the drawings. For illustrating the present invention, the examples and embodiments will be described in connection with a cellular communication network based on a 3GPP based communication system, for example an LTE-A based system. However, it is to be noted that the present invention is not limited to an application using such types of communication system, but is also applicable in other types of communication systems and the like.

A basic system architecture of a communication network where examples of embodiments of the invention are applicable may comprise a commonly known architecture of one or more communication systems comprising a wired or wireless access network subsystem and a core network. Such an architecture may comprise one or more access network control elements, radio access network elements, access service network gateways or base transceiver stations, such as a base station, a LA node or an eNB, which control a coverage area also referred to as a cell (macro cell, LA cell) and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element or terminal device like a UE and a communication network control element like a BS, LA node or eNB, besides those described in detail herein below.

Furthermore, the described network elements, such as terminal devices like UEs, communication network control elements of a cell, like an eNB, an LA node and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

It is to be noted that in the following some examples of embodiments of the invention are described which are related to a case where a communication connection is controlled by using a message from a communication element such as a UE which comprises a request for certain resources, such as an initial access request where resources for an establishment of a communication connection are requested, a scheduling request where a change of resources for already established connections is requested, or a cell change or handover request where a switch of a communication connection (and hence of resources) from one cell to another cell is requested.

However, the message used for the communication control by the UE can be also another sort of message or request. According to some other examples of embodiments of the invention, the message is, for example, a response of the UE for a paging message, indicating also a cell selection preferred by the UE. According to some examples of embodiments of the invention, the indicated cell selection preference is limited to DL direction in the case that the communication network employs, for example, Coordinated Multipoint (CoMP) techniques. According to some other examples of embodiments of the invention, the message contains a measurement report or conveys information between cells. Such message is used, for example, to assist a distributed inter-cell coordination, especially when interfaces on wired connections between the cells do not exist, are not reliable, are not configured, or do not have sufficiently low latency. For example, according to some examples of embodiments of the invention, the message contains a timing difference between one cell (which can be e.g. a source cell described later) and another cell (which can be e.g. the target cell), which may be used to assist distributed network synchronization. In the case of TDD network employing a flexible and dynamic configuration of UL and DL subframes, according to some examples of embodiments of the invention, the message contains information on UL and DL subframe configuration in the source cell or on DL power settings in the source cell in order to assist e.g. an inter-cell interference coordination.

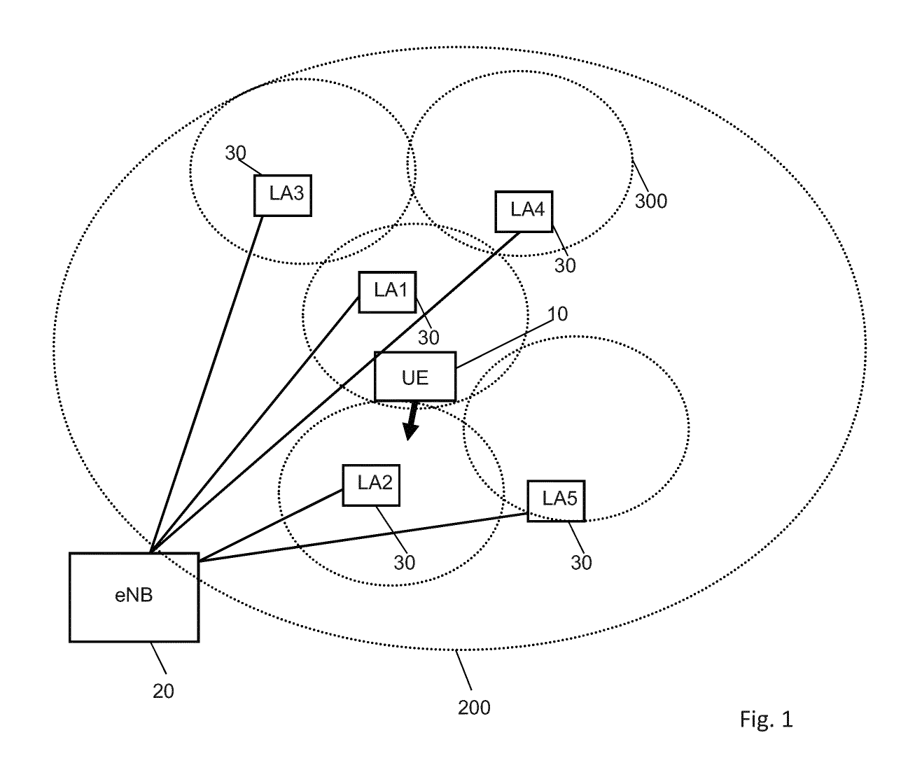

With regard to FIG. 1, a diagram illustrating a general configuration of a communication network is shown where some examples of embodiments of the invention are implemented. It is to be noted that the configuration shown in FIG. 1 shows only those devices, network elements and parts which are useful for understanding principles underlying the examples of embodiments of the invention. As also known by those skilled in the art there may be several other network elements or devices involved in a communication between the communication device (UE) and the network which are omitted here for the sake of simplicity.

In FIG. 1, a communication network configuration is illustrated in which some examples of embodiments of the invention are implementable. The network according to FIG. 1 is for example based on 3GPP specifications and forms a heterogeneous network including a primary serving cell (Pcell) and plural secondary cells (Scells). It is to be noted that the general functions of the elements described in connection with FIG. 1 as well as of reference points/interfaces therebetween are known to those skilled in the art so that a detailed description thereof is omitted here for the sake of simplicity.

As shown in FIG. 1, in the exemplary communication network, a Pcell 200 is formed by a macro cell controller i.e. by a communication network control element such as an eNB 20. The eNB 20 provides, for example, a connection to the core network of the communication network.

In the macro cell 200, plural small cells or secondary cells (Scells) 300 are located. According to some examples of embodiments of the invention, the small cells are LA cells. It is to be noted that other examples of embodiments of the invention are implementable in a scenario where plural cells of a same type are located adjacent to each other, i.e. cells having a comparable coverage area.

Each LA cell is controlled by an own communication network control element, such as an eNB or LA node 30. In the example of FIG. 1, four LA cells (LA1 to LA5) are depicted, but the number is not limited thereto and can be greater or smaller than four.

The eNB 20 and the LA nodes 30 are connected with each other, for example, by a backhaul network, which is based e.g. on so-called X2 interfaces, so as to enable the nodes to directly communicate with each other. Even though not shown in FIG. 1, according to some examples of embodiments of the invention, the LA nodes are also connected with each other via a corresponding interface, e.g. by respective X2 interfaces, or the links between the LA nodes are relayed via a central node, such as the macro eNB 20.

Furthermore, a communication element or terminal device (UE) 10 is assumed to be located in the communication network. The UE 10 is configured to communicate with the communication network via at least one of the eNB 20 or an LA node 30 by using for example an air interface.

As described above, when the UE 10 communicates with a destination, resources from at least one cell are required. The cell of which resources are to be requested is also referred to as a target cell. For example, in case of an initial access to the network for starting a communication, at least one of the macro cell and the LA cells is selected by the UE 10 as the target cell. In case the UE 10 is already connected to the network, e.g. via one of the LA cells like LA1, and the UE 10 wishes to change the cell (i.e. handover to a new target cell such as LA2, as indicated by an arrow in FIG. 1), LA2 is the new target cell while LA1 is referred to as a source cell. On the other hand, e.g. in case the UE 10 wishes additional resources or the like in the cell where it is presently located (in FIG. 1, for example, the LA1 cell), resource request procedure with LA1 as target cell is conducted.

According to some examples of embodiments of the invention, the resource request procedure relates to measures regarding a physical layer towards small cells, such as in cell selection and initial access schemes, and hence to an LA optimization of e.g. LTE or LTE-A based communication systems. That is, according to some examples of embodiments of the invention, a (UE centric) resource request procedure is provided, e.g. as an initial access procedure using specific channels which enables also an UE autonomous cell selection, e.g. for small cells scenarios.

According to a comparative example, it could be contemplated to use an UL synchronization and contention based access based on RACH preamble. In case of LA cells, it is however to be considered that such LA cells are quite small, especially compared to a macro cell. Thus, the requirements set for RACH usage are different. For example, if +/−0.5·s UL timing error is tolerable in LA, as it is in a conventional LTE based network, timing control is not needed in cells having e.g. a cell range of 150 meters or less (which is a typical value assumed for LA cells which have a cell range of e.g. 50-150 meter). Hence, a RACH structure can be used for LA cells so that more efficient use of resources is achieved while the remaining RACH requirements are met. Without TA, the UL synchronization is based DL timing and contention based UL transmission can be based on the “normal” UL signals. Then a RACH preamble is not needed. However, it is to be noted that existing networks such as LTE does not support an UE autonomous cell selection in connected mode. Furthermore, the network controlled cell selection introduces lot of signaling which is challenging in dense LA deployment, as discussed above. Consequently, a RACH structure is not optimal, especially in an LA scenario as depicted in FIG. 1.

According to some examples of embodiments of the invention, a procedure for requesting resources from a cell by a UE for communication is provided which uses a channel optimized for accessing LA nodes and allows e.g. an UE autonomous cell selection. Furthermore, according to some examples of embodiments of the invention, the UE autonomous cell selection is possible independent of whether the UE has or has not a valid identity in a target cell.

That is, according to some examples of embodiments of the invention, when the UE 10 in FIG. 1 detects that e.g. data arrives in UE's buffer, the UE 10 selects a desired cell of the macro cell and/or the LA cells as a target cell for communication and starts a procedure for requesting the necessary resources for the communication of the date. For this purpose, the UE 10 sends a message, such as a resource request like an access request message or scheduling request message. According to some examples of embodiment of the invention, the message (resource request) is transmitted via suitable resources. However, according to some other examples of embodiments of the invention, the message (resource request) is transmitted via specific resources reserved for the transmission of the message (resource request).

According to some examples of embodiments of the invention, the reserved resources are reserved for the resource request transmission in plural of the cells. That is, for example, neighboring cells such as LA1 to LA5 but also the macro cell (i.e. cells which are configured to support the resource request procedure according to some examples of embodiments of the invention) are all configured to reserve the same time and frequency resources for the transmission of the resource request by a UE performing the resource request procedure. It is to be noted that according to some examples of embodiments of the invention a UE such as UE 10 is configured to identify the respective LA cells for example on the basis of system information which are broadcasted or sent by the eNB (or LA nodes). Furthermore, according to some examples of embodiments of the invention, information about the reserved resources for the resource request transmission are broadcasted by the cells, i.e. by the eNB 20 and/or the LA nodes 30, wherein information about time/frequency resources reserved for the resource request transmission are indicated, for example.

According to some examples of embodiments of the invention, the message (e.g. the resource request, such as an access message), includes at least information about the identity of the requesting UE, e.g. in a corresponding identity field, and information about the identity of the target cell, e.g. in a corresponding identity field.

The target cell identity is, according to some examples of embodiments of the invention, a physical cell ID (such as PCI in LTE based networks). According to some examples of embodiments of the invention, this acts also as an error protection in the target cell, wherein the target cell identity acts as pre-known bit-sequence in the communication network control element site.

The used UE identity depends, according to some examples of embodiments of the invention, on whether the UE 10 has a valid identity in the target cell or not. For example, according to some examples of embodiments of the invention, a physical UE ID (such as C-RNTI in LTE based networks) is used when the UE 10 has a valid identity in the target cell. On the other hand, according to some examples of embodiments of the invention, the UE identity is a temporal identifier when the UE 10 does not have an allocated identifier or valid identity in the target cell. It is to be noted that according to some examples of embodiments of the invention, the temporal identifier for the UE 10 is selected in different space than the actual UE ID of the UE 10 (C-RNTI, for example) in order to avoid UE ID collisions among LA nodes. Furthermore, according to some examples of embodiments of the invention, an external network node is responsible for a UE ID allocation in certain areas. For example, this functionality is located in a predetermined node such as the eNB 20.

According to some examples of embodiments of the invention, the UE identity in the resource request acts as an error protection in the source cell.

According to some examples of embodiments of the invention, the UE and target cell identifiers are jointly coded by using a single codeword.

On the other hand, according to some examples of embodiments of the invention, in the cells supporting the resource request procedure, such as LA1 to LA5 and macro cell 200, the respective communication network control elements 20, 30 (eNB, LA nodes) scan on the reserved resources for a message related to the resource request, e.g. an access message or the like. That is, according to some examples of embodiments of the invention, the communication network control elements conduct a blind decoding on the reserved. For the decoding, the ID of the own cell (i.e. ID of LA 1 in case of LA1 cell, ID of eNB 20 in case of macro cell) is used, and a stored set of UE IDs and corresponding identifiers (containing both temporal UE identifiers and e.g. C-RNTIs) is used.

Depending on the result of the decoding, according to some examples of embodiments of the invention, the communication network control element (eNB 20, LA node 30) executed a respective following processing.

When the LA node/eNB detects its own cell ID, it decides on an assignment of resources for communication to the requesting UE 10 in case the UE has a valid identity, i.e. in case e.g. the C-RNTI is detected. Otherwise, if the own cell ID is detected but the UE 10 does not have a valid identity (i.e. a temporal UE identifier detected), a procedure for acquiring the UE identity is started.

On the other hand, in case the LA node/eNB detects not its own cell ID but a valid UE identity (e.g. C-RNTI), it recognizes that the (previously connected) UE 10 tries to access to another cell (e.g. neighboring cell LA2). It is to be noted that according to some examples of embodiments of the invention each communication network control element knows the UEs (i.e. the corresponding C-RNTI or the like) which are connected to the own cell. In this case, according to some examples of embodiments of the invention, the present (source) cell (i.e. the communication network control element thereof) performs a processing by using e.g. a higher layer signaling via different network nodes (e.g. by using the X2 interfaces between source and target cells) so as to inform the actual target cell (e.g. LA2) about the resource request. According to some examples of embodiments of the invention, by means of this processing, the target cell, even if it has not received the resource request, is informed e.g. about the UE ID and is able to act accordingly (e.g. decide on resource allocation etc.).

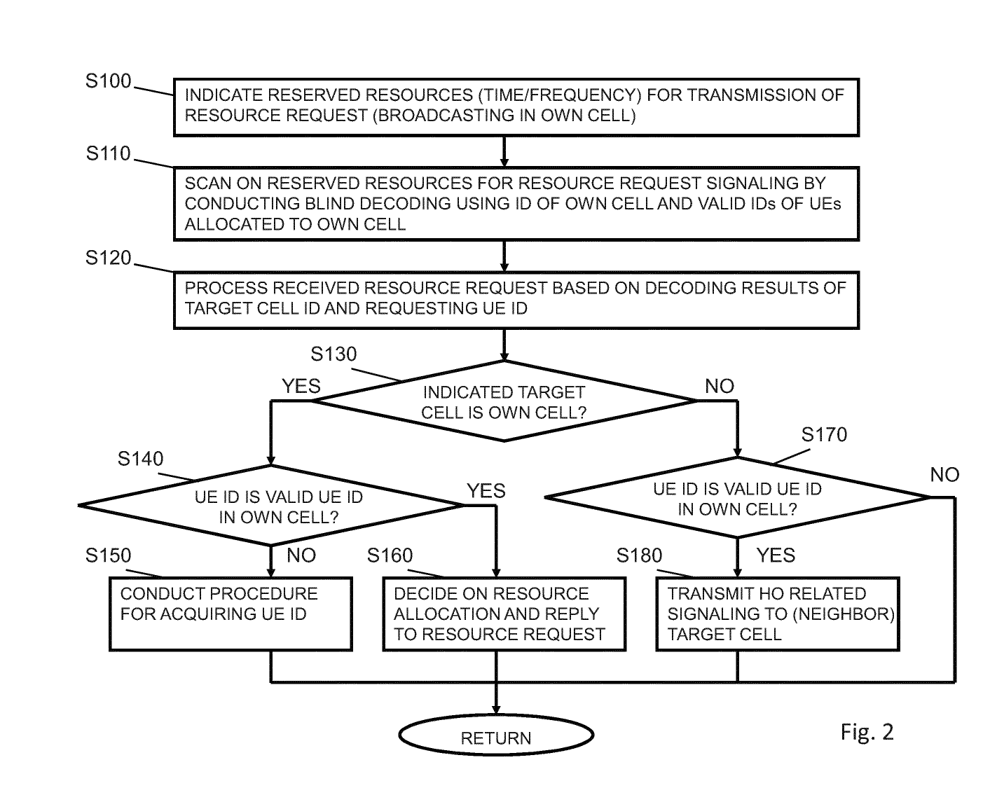

FIG. 2 shows a flowchart illustrating a processing executed in a communication network control element like the eNB 20 or an LA node 30 of FIG. 1 according to some examples of embodiments of the invention in a resource request procedure as described above.

In step S100, in the own cell, an indication of time and frequency resources reserved for a resource request transmission is broadcasted or the like. According to some examples of embodiments of the invention, the corresponding time and frequency resources being reserved for the resource request transmission are selected in such a manner that they are the same as in a neighboring cell of the own cell (i.e. LA1 to LA5 and macro cell reserve the same resources, for example). It is to be noted that step S100 is optional and can be also omitted, for example in case the resources are already preset, or the like.

In step S110, the reserved resources are scanned (i.e. blind decoding is conducted) so as to receive a resource request of UE 10. The resource request comprises information indicating an identity of the requesting UE (for example, a physical UE ID such as C-RNTI, a temporal identifier related to the UE, etc.), and information indicating an identity of the target cell from which resources are requested (for example a known physical identification element of the target cell). As indicated above, according to some examples of embodiments of the invention, the information indicating the UE ID and the information indicating the target cell ID are coded by using a single codeword.

According to some examples of embodiments of the invention, the resource request is for requesting resources for data transmission in the target cell, in at least one of an initial access of the requesting UE to the target cell, a scheduling request for a communication of the requesting UE in the target cell, and a cell change of the requesting UE to the target cell.

For conducting the blind decoding, according to some examples of embodiments of the invention, in step S110, the ID of the own cell and UE ID being known at the own cell are used.

In step S120, on the basis of a result of the decoding, the contents of the resource request, in particular the information about the requesting UE and the target cell, are processed. Specifically, it is determined whether or not the target cell indicated in the received resource request is the own cell (step S130), and whether or not the communication element is a known communication element allocated to the own cell, i.e. whether the UE ID is a valid UE identity in the own cell (steps S140 and S170).

In case it is determined in step S130 that the target cell indicated in the received resource request is the own cell (YES in step S130), step S140 is conducted for deciding whether the UE is a known communication element allocated to the own cell. If the decision in step S140 is positive, step S160 is executed in which it is decided whether communication resources are allocated (e.g. on the basis of information in the resource request), wherein the decision is also sent to the requesting UE in reply to the resource request.

Otherwise, in case the decision in step S140 is negative (no valid UE identity determined), step S150 is executed for acquiring the UE identity.

On the other hand, in case the decision in step S130 is negative (target cell is not the own cell), and the UE ID is determined to be a valid UE ID (Yes in step S170), a transmission of a HO related signaling (e.g. via higher layer signaling using X2 interface or the like) towards the actual target cell is executed in step S180. It is to be noted that in case the decision in step S140 is also negative (UE ID not known), the processing returns or is ended.

It is to be noted that step S120 can be also replaced, according to some examples of embodiments of the invention, by a step (not shown) of receiving, from a neighboring cell, an indication regarding a resource request received at the neighboring cell wherein the target cell indicated in the resource request is the own cell (i.e. when the source cell has received the resource request, but the cell ID was not that of the source cell but of this cell). In this case, steps S140 to S160 are executed according to some examples of embodiments of the invention on the basis of this indication.

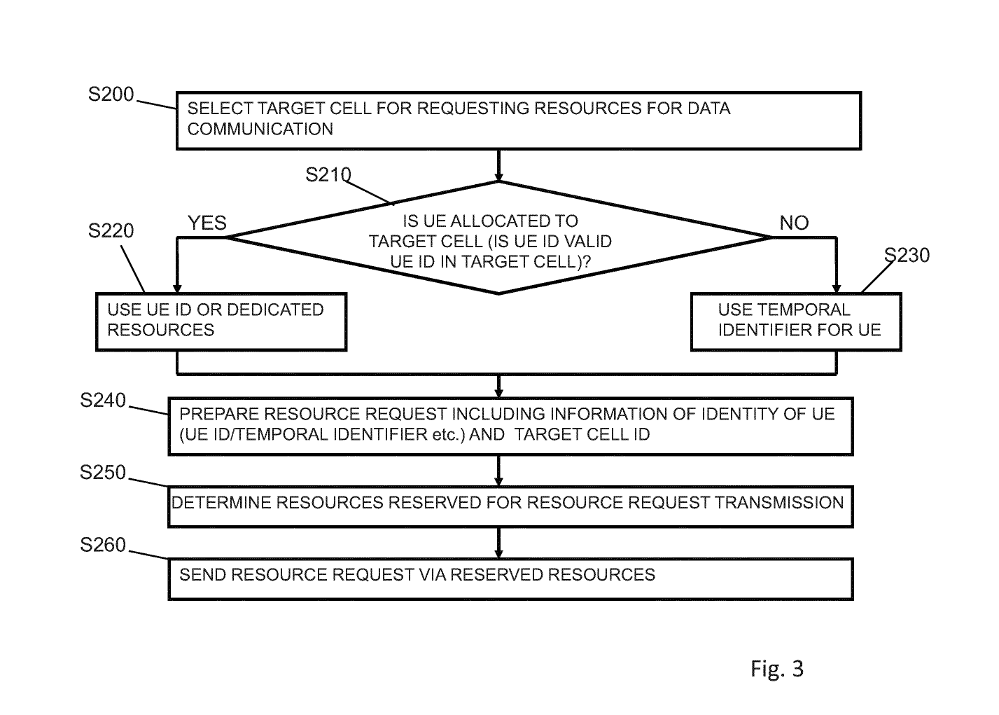

FIG. 3 shows a flowchart illustrating a processing executed in a communication element like the UE 10 of FIG. 1 according to examples of embodiments of the invention in a resource request procedure as described above.

In step S200, the UE 10 selects at least one target cell from a plurality of communication cells (LA1 to LA5, macro cell). The selection is based, according to some examples of embodiments of the invention, on connection quality considerations or the like.

In step S210, based on the selection of the target cell, it is decided whether the UE 10 has a valid ID at the target cell, i.e. whether it is known to the target cell or not. In case the decision in step S210 is positive, the corresponding UE ID (e.g. C-RNTI) is selected to be used in step S220. Otherwise, in case the decision in step S210 is negative, a temporal identifier for the UE 10 is selected to be used in step S230.

Next, step S240 is executed where a resource request is prepared. According to some examples of embodiments of the invention, the resource request is for requesting resources for data transmission in the target cell, in at least one of an initial access of the requesting UE to the target cell, a scheduling request for a communication of the requesting UE in the target cell, and a cell change of the requesting UE to the target cell.

According to some examples of embodiments of the invention, the resource request comprises information indicating the UE ID corresponding to step S220 or S230, and information indicating the identity of the selected target cell from which resources are requested. According to some examples of embodiments of the invention, the information indicating the identity of the requesting UE and the information indicating the identity of the target cell are coded by using a single codeword.

In step S250, resources reserved for transmitting a resource request according to some examples of embodiments of the invention are determined, for example on the basis of information broadcasted by the cells (according to step S100 in FIG. 2), or according to predetermined resources. As described above, according to some examples of embodiments of the invention, time and frequency resources reserved for the resource request transmission are the same in the plural cells (LA1 to LA5, macro cell, etc.).

In step S260, the resource request is transmitted by using the reserved resources.

According to some examples of embodiments of the invention, the selection of the resources for the transmission of the resource request is made in a contention based manner (resources are broadcasted to all UEs). However, according to some examples of embodiments of the invention, dedicated resources for certain UEs are provided. That is, the transmission of the resource request via these dedicated resources is allowed only for certain UEs which are known to the source and/or target cell. That is, instead of using a UE ID in the resource request message, the information about the identity of the requesting UE is conveyed by using these dedicated resources (e.g. in step S220 of FIG. 3) which allows the communication network control element to determine that the UE is a known UE (e.g. in steps S140 and S170 of FIG. 2).

According to some examples of embodiments of the invention, the resource request comprises further information bits, such as information about a sender identifier, a receiver identifier, and information on required service, e.g., on a eRAB QoS buffer status report. According to some examples of embodiments of the invention, these information parts are jointly coded by using a single codeword.

According to some examples of embodiments of the invention, specific PUSCH PRBs are reserved for the transmission of the resource request, wherein the same PRBs are reserved from adjacent cells.

Furthermore, according to some examples of embodiments of the invention, instead of using PUSCH PRB, PUCCH channel is used. In this case, identity spaces are smaller due to a limited number of bits. For example, PUCCH format 3 can convey 20 bits. The bits can be shared e.g. such that 9 bits (512 IDs) are reserved for target cell identity and the remaining bits (11 bits→2048 IDs) are reserved for the UE identity.

PUSCH/PUCCH resources can be used according to some examples of embodiments of the invention e.g. due to the limited range of LA cell, where no TA is needed and the synchronization is simply derived from DL signal.

According to some examples of embodiments of the invention, the information about the UE and target cell IDs, i.e. corresponding identifiers are conveyed by means of dedicated sequences. For example, the target cell is identified by sequences dedicated to a cell index and the UE is identified by sequences dedicated to the UE identity. According to some examples of embodiments of the invention, sequences are divided into target cell identification sequences and UE identification sequences. According to some examples of embodiments of the invention, corresponding sequences consist of a sequence used e.g. in PUCCH format 1 and/or RACH preamble. The usage of PUCCH format 1 is preferable over a usage of RACH preamble, in particular in a scenario with plural LA cells as shown in FIG. 1, because without TA the UL synchronization can be based on the DL timing and contention based UL transmission can be based on the “normal” UL signals. Therefore, according to some examples of embodiments of the invention, the RACH preamble is not needed at all.

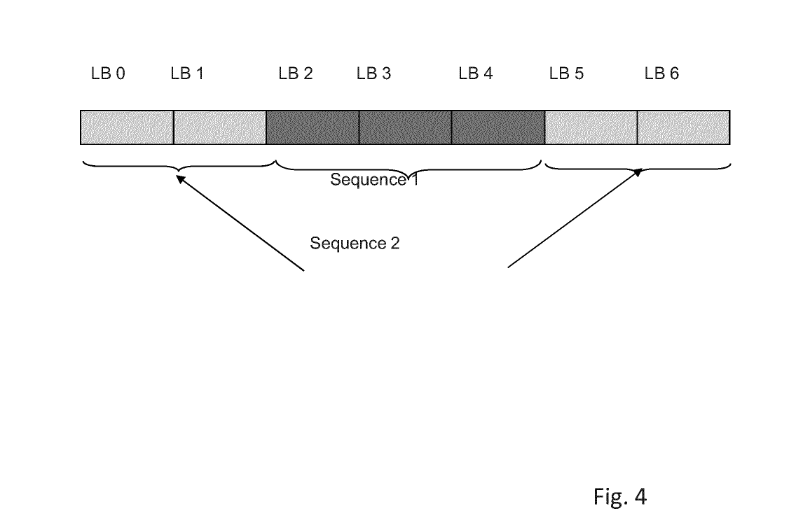

FIG. 4 shows a diagram illustrating a slot structure for a resource request according to some examples of embodiments of the invention. Specifically, FIG. 4 shows a more detailed solution for PUCCH format 1 arrangements.

FIG. 4 shows a slot structure of 3GPP based synchronized scheduling request. Each long block (LB0 to LB6, for example) is composed of a computer generated (CG) sequence with terminal specific cyclic shift. The length of a CG sequence is for example 12 and it has zero autocorrelation zone property. Each of the LBs is multiplied with terminal specific orthogonal cover sequences (sequence 1 and sequence 2), as illustrated on FIG. 4. The UE sends a scheduling request with on-off keying, i.e. scheduling request burst is transmitted on the reserved resources for a positive scheduling request. According to some examples of embodiments of the invention, the sequences are divided to target cell identification sequences and UE identification sequences in such that Sequence 1 is used for the target cell identity (using LB2 to LB4) and Sequence 2 is used for the UE identity (using LB0, LB1, LB5, LB6). This results in 36 orthogonal sequences available for target cell identity and 48 sequences for UE identity, respectively. The communication network control element (eNB 20, LA node 30) correlates the received signals by using sequences corresponding to its own cell ID and UE identifiers in the cell (e.g. in step S110, S120 of FIG. 2).

It is to be noted that according to some examples of embodiments of the invention error protection can be handled by threshold detection. That is, the target cell ID space is large enough compared to number of legal PCIs so that the probability of a false alarm is kept low.

In the following, according to some examples of embodiments of the invention, processing of the resource request procedure as discussed above in several error cases is explained.

Assuming an error case where the target cell fails to detect the resource request or does not respond to the resource request, according to some examples of embodiments of the invention, the UE 10 repeats the transmission of the resource request in following transmission opportunities with a random offset, a power ramp up etc. However, according to some examples of embodiments of the invention, as indicated above, in case the source cell detects the resource request, that will for example trigger an X2 signaling to the target cell. Based on the signaling, the target cell is able to decide on an assignment of resources and send a response (e.g. a DL grant signal) to the requesting UE (e.g. for RRC connection reconfiguration).

Assuming an error case where an admission control function of the target cell intends to deny the resource request, which is based for example on a processing of information in the resource request, such as signaled eRAB QoS information, the target cell indicates according to some examples of embodiments of the invention the denial to the UE in its response to the resource request. This is also possible, according to some examples of embodiments of the invention, when the target cell receives the HO related signaling from the source cell, wherein the denial is sent e.g. to the source cell.

Assuming an error case where the source cell fails to detect the resource request to another cell, the target cell requests from the source cell ID from the UE, and sends a request (for related higher layer signaling) to the source cell via e.g. the X2 link.

According to some examples of embodiments of the invention, the UE is able to indicate a HO request to both the target and the source cell by using a single message, including special error protection schemes. According to some examples of embodiments of the invention, the UE sends its own identity and the target cell identity (and corresponding PHY layer procedures) via a specific access channel (reserved resources) in order to obtain resources for data transmission in the target cell. Since, according to some examples of embodiments of the invention, the UE connecting to a small cell does not need TA (and possibly also not an initial power setting), random access procedure is simplified. Furthermore, random access (for initial access), scheduling request and active state UE cell change are unified with the same resource request message. Signaling delays can be avoided. Thus, according to some examples of embodiments of the invention, the resource request procedure can be used also in active mode.

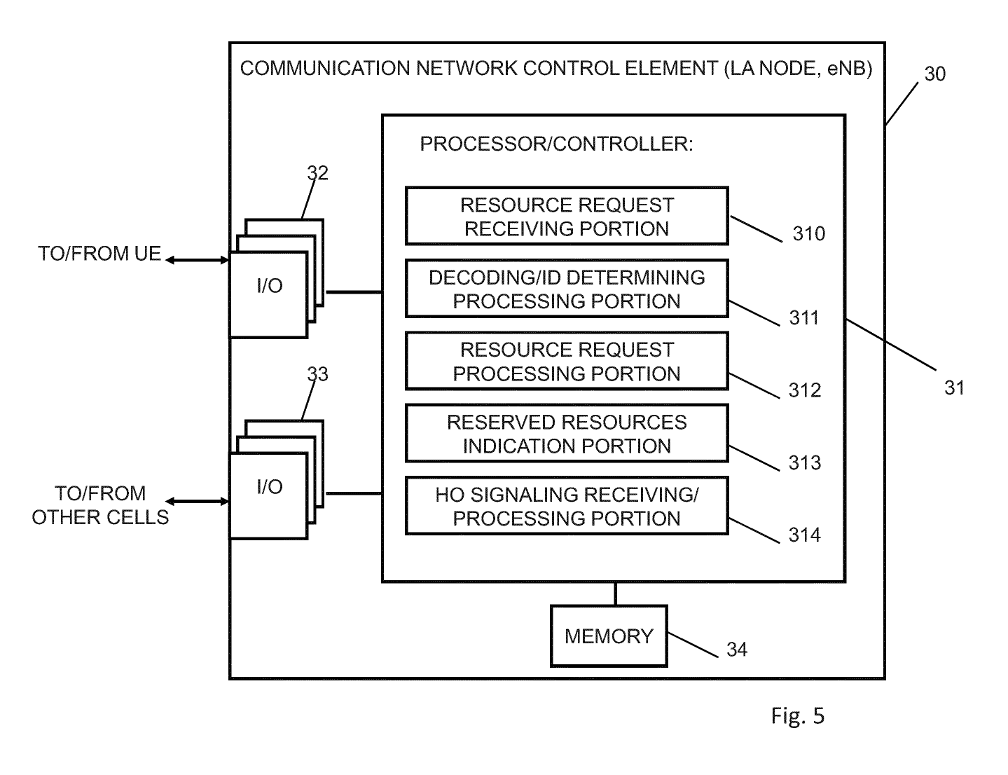

In FIG. 5, a block circuit diagram illustrating a configuration of a communication network control element, such as of the eNB 20 or a LA node 30, is shown, which is configured to implement the procedure for resource requesting as described in connection with some of the examples of embodiments of the invention. It is to be noted that the communication network control element (LA node 30 or eNB 20) shown in FIG. 5 may comprise several further elements or functions besides those described herein below, which are omitted herein for the sake of simplicity as they are not essential for understanding the invention. Furthermore, even though reference is made to an LA node or eNB, the communication network control element may be also another device having a similar function, such as a chipset, a chip, a module etc., which can also be part of a communication network control element or attached as a separate element to a communication network control element, or the like.

The communication network control element shown in FIG. 5 may comprise a processing function or processor 31, such as a CPU or the like, which executes instructions given by programs or the like related to the resource request mechanism. The processor 31 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference signs 32 and 33 denote transceiver or input/output (I/O) units (interfaces) connected to the processor 31. The I/O units 32 may be used for communicating with one or more communication elements like UEs. The I/O units 33 may be used for communicating with one or more communication network control elements like other eNBs or LA nodes (e.g. via X2 interface). The I/O units 32 and 33 may be a combined unit comprising communication equipment towards several network elements, or may comprise a distributed structure with a plurality of different interfaces for different network elements. Reference sign 34 denotes a memory usable, for example, for storing data and programs to be executed by the processor 31 and/or as a working storage of the processor 31.

The processor 31 is configured to execute processing related to the above described resource request procedure. In particular, the processor 31 comprises a sub-portion 310 as a processing portion which is usable for receiving a resource request. Furthermore, the processor 31 comprises a sub-portion 311 usable as a portion for decoding processing and cell/UE ID determination using a received resource request. The portions 310 and 311 may be configured to perform processing according to step S110 of FIG. 2, for example. Furthermore, the processor 31 comprises a sub-portion 312 usable as a portion for processing a resource request. The portion 312 may be configured to perform processing according to steps S120 to S180 of FIG. 2, for example. In addition, the processor 31 comprises a sub-portion 313 as a processing portion which is usable for indicating reserved resources for resource request transmission. The portion 313 may be configured to perform processing according to step S100 of FIG. 2, for example. Furthermore, the processor 31 comprises a sub-portion 314 usable as a portion for receiving and processing a HO related signaling from another LA node or eNB (source cell), based on e.g. step S180 of FIG. 2.

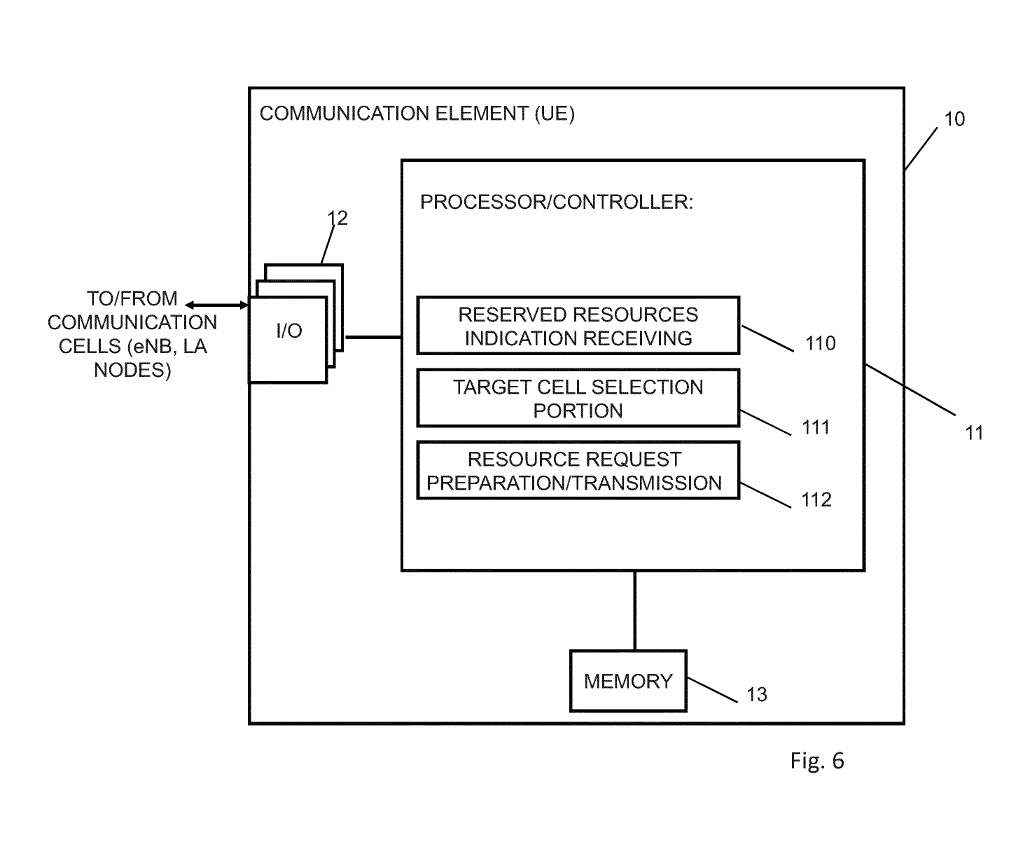

In FIG. 6, a block circuit diagram illustrating a configuration of a communication element, such as of UE 10, is shown, which is configured to implement the resource request procedure as described in connection with some examples of embodiments of the invention. It is to be noted that the communication element or UE 30 shown in FIG. 6 may comprise several further elements or functions besides those described herein below, which are omitted herein for the sake of simplicity as they are not essential for understanding the invention. Furthermore, even though reference is made to a UE (or terminal device), the communication element may be also another device having a similar function, such as a chipset, a chip, a module etc., which can also be part of a UE or attached as a separate element to a UE, or the like.

The communication element or UE 10 may comprise a processing function or processor 11, such as a CPU or the like, which executes instructions given by programs or the like related to the resource request mechanism. The processor 11 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 12 denotes transceiver or input/output (I/O) units (interfaces) connected to the processor 11. The I/O units 12 may be used for communicating with one or more communication network control elements like LA nodes 30 or eNB 20. The I/O units 12 may be a combined unit comprising communication equipment towards several network elements, or may comprise a distributed structure with a plurality of different interfaces for different network elements. Reference sign 13 denotes a memory usable, for example, for storing data and programs to be executed by the processor 11 and/or as a working storage of the processor 11.

The processor 11 is configured to execute processing related to the above described resource request procedure. In particular, the processor 11 comprises a sub-portion 110 as a processing portion which is usable for receiving and processing an indication of reserved resources for a transmission of a resource request. The portion 110 may be configured to perform processing related to step S250 of FIG. 3, for example. Furthermore, the processor 11 comprises a sub-portion 111 usable as a portion for selecting a target cell from which resources for communication are to be requested. The portion 111 may be configured to perform processing according to step S200 of FIG. 3, for example. Furthermore, the processor 11 comprises a sub-portion 112 usable as a portion for preparing and transmitting a resource request via the reserved resources. The portion 112 may be configured to perform processing according to steps S210 to S240 and S260 of FIG. 3, for example.

As indicated above, the above described mechanism according to some examples of embodiments of the invention are related, as a message to be processed, to a resource request message, wherein the following processing steps, such as an allocation of resources, are also related to this type of message. According to some further examples of embodiments of the invention, as described above, in case another sort of message being different to a resource request is sent by the UE and processed in the LA node or eNB, such as a response of the UE for a paging message, a measurement report etc., based on the determination e.g. in steps S120, S130, S140 and S170, other final processing steps can be executed, which are related to the respective content of the message, such as a detection an processing of a cell selection preference, a measurement report processing, a timing difference determination between cells, etc., on the basis of the determination related to the UE sending the message and the target cell.

According to some further examples of embodiments of the invention, there is provided an apparatus comprising receiving means for receiving a message, the message comprising information indicating an identity of a communication element and information indicating an identity of a communication cell as a target cell, decoding processing means for conducting a decoding on transmissions for the message by using identification information of an own cell and identification information of communication elements being valid in the own cell, and determining means for determining, on the basis of a result of the decoding, whether or not the target cell indicated in the message is the own cell, and whether or not the communication element identified in the message is a known communication element allocated to the own cell.

In addition, according to some further examples of embodiments of the invention, there is provided an apparatus comprising selecting means for selecting at least one target cell from a plurality of communication cells with which a communication element can communicate, and transmission means for preparing a message comprising information indicating an identity of a communication element and information indicating an identity of the communication cell selected as the target cell from, and for causing transmission of the message.

For the purpose of the present invention as described herein above, it should be noted that
an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present invention implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable communication networks, stations and transmission nodes may be or comprise any device, apparatus, unit or means by which a station, entity or other user equipment may connect to and/or utilize services offered by the access network; such services include, among others, data and/or (audio-) visual communication, data download etc.;
a user equipment or communication network element (station) may be any device, apparatus, unit or means by which a system user or subscriber may experience services from an access network, such as a mobile phone or smart phone, a personal digital assistant PDA, or computer, or a device having a corresponding functionality, such as a modem chipset, a chip, a module etc., which can also be part of a UE or attached as a separate element to a UE, or the like;
method steps likely to be implemented as software code portions and being run using a processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to examples of embodiments of the invention, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is provided a mechanism for controlling a procedure for requesting resources for a communication in a communication network by a terminal device or UE. When the UE has selected a target cell from a plurality of communication cells, such as local area cells, a message such as a resource request comprising information indicating an identity of the requesting UE and information indicating an identity of the target cell from which resources are requested is prepared and transmitted, for example via communication resources reserved for a transmission of the message. A controller of a cell, such as an eNB or a LA node, scans the reserved resources for receiving a message such as the resource request from a UE. The message is decoded by using identification information of the own cell and identification information of UEs being valid in the own cell. Then, it is determined whether the received message indicates as the target cell the own cell, and whether the UE is a known UE allocated to the own cell. Based on this determination, the message such as the resource request is processed or another cell is informed thereabout.

Although the present invention has been described herein before with reference to particular embodiments thereof, the present invention is not limited thereto and various modifications can be made thereto.

1.-46. (canceled)

47. An apparatus comprising:
at least one processor,
at least one interface to at least one other network element, and
at least one memory for storing instructions to be executed by the processor, wherein
the at least one memory and the instructions are configured to, with the at least one processor, cause the apparatus at least to perform:
a receiving function configured to receive a message, the message comprising information indicating an identity of a communication element and information indicating an identity of a communication cell as a target cell,
a decoding processing function configured to conduct a decoding on transmissions for the message by using identification information of an own cell and identification information of communication elements being valid in the own cell, and
a determining function configured to determine, on the basis of a result of the decoding, whether or not the target cell indicated in the message is the own cell, and whether or not the communication element identified in the message is a known communication element allocated to the own cell.

48. The apparatus according to claim 47, wherein the at least one memory and the instructions are configured to, with the at least one processor, cause the apparatus at least to further perform:
a processing function configured to conduct a processing of the message on the basis of the result of the determining function, wherein the processing function is configured:
in case the determining function determines that the target cell indicated in the received message is the own cell and the communication element is a known communication element allocated to the own cell, to decide on an allocation of communication resources on the basis of information in the message, and to cause sending of a response message to the received message indicating the decision on the resource allocation,
in case the determining function determines that the target cell indicated in the received message is the own cell and the communication element is an unknown communication element, to conduct a procedure for acquiring the identity of the communication element, and
in case the determining function determines that the target cell indicated in the received message is not the own cell and the communication element is a known communication element allocated to the own cell, to cause a transmission of a handover related signaling to a cell being the target cell indicated in the message for informing the target cell about the received message.

49. The apparatus according to claim 47, wherein the at least one memory and the instructions are configured to, with the at least one processor, cause the apparatus at least to further perform:
a transmission function configured to send in the own cell an indication of time and frequency resources reserved for the transmission of the message, wherein the time and frequency resources reserved for the transmission of the message are selected to be the same as time and frequency resources reserved for a transmission of the message in a neighboring cell of the own cell.

50. The apparatus according to claim 47, wherein the at least one memory and the instructions are configured to, with the at least one processor, cause the apparatus at least to further perform:
a handover signaling receiving and processing function configured to receive, from a neighboring cell, an indication regarding a message received at the neighboring cell wherein the target cell indicated in the message is the own cell, wherein the handover signaling receiving and processing function is further configured to decide on an allocation of resources on the basis of the indication.

51. The apparatus according to claim 47, wherein the information indicating the identity of the communication element identified in the message and the information indicating the identity of the target cell are coded by using a single codeword.

52. The apparatus according to claim 47, wherein the information indicating the identity of the communication element and the information indicating the identity of the target cell are conveyed in the message as dedicated sequences, wherein one sequence is dedicated to the identity of the communication element and another sequence is dedicated to the identity of the target cell, wherein the decoding function is further configured correlate the received message by using sequences corresponding to the identification of the own cell and corresponding to the identification of communication elements being valid in the own cell.

53. A method comprising:
receiving a message, the message comprising information indicating an identity of a communication element and information indicating an identity of a communication cell as a target cell,
conducting a decoding on transmissions for the message by using identification information of an own cell and identification information of communication elements being valid in the own cell, and
determining, on the basis of a result of the decoding, whether or not the target cell indicated in the message is the own cell, and whether or not the communication element identified in the message is a known communication element allocated to the own cell.

54. The method according to claim 53, further comprising
processing the message on the basis of the result of the determining, the processing comprises:
in case it is determined that the target cell indicated in the received message is the own cell and the communication element is a known communication element allocated to the own cell, deciding on an allocation of communication resources on the basis of information in the message, and causing sending of a response message to the received message indicating the decision on the resource allocation,
in case it is determined that the target cell indicated in the received message is the own cell and the communication element is an unknown communication element, conducting a procedure for acquiring the identity of the communication element, and
in case it is determined that the target cell indicated in the received message is not the own cell and the communication element is a known communication element allocated to the own cell, causing a transmission of a handover related signaling to a cell being the target cell indicated in the message for informing the target cell about the received message.

55. The method according to claim 54, further comprising:
sending in the own cell an indication of time and frequency resources reserved for the transmission of the message, wherein the time and frequency resources reserved for the transmission of the message are selected to be the same as time and frequency resources reserved for a transmission of the message in a neighboring cell of the own cell.

56. The method according to claim 53, further comprising:
receiving, from a neighboring cell, an indication regarding a message received at the neighboring cell wherein the target cell indicated in the message is the own cell, and
deciding on an allocation of resources on the basis of the indication.

57. The method according to claim 53, wherein the information indicating the identity of the communication element identified in the message and the information indicating the identity of the target cell are coded by using a single codeword.

58. The method according to claim 53, wherein the information indicating the identity of the communication element and the information indicating the identity of the target cell are conveyed in the message as dedicated sequences, wherein one sequence is dedicated to the identity of the communication element and another sequence is dedicated to the identity of the target cell, the method further comprising:
correlating the received message by using sequences corresponding to the identification of the own cell and corresponding to the identification of communication elements being valid in the own cell.

59. An apparatus comprising:
at least one processor,
at least one interface to at least one other network element, and
at least one memory for storing instructions to be executed by the processor, wherein
the at least one memory and the instructions are configured to, with the at least one processor, cause the apparatus at least to perform:
a selection function configured to select at least one target cell from a plurality of communication cells with which a communication element can communicate, and
a transmission function configured to prepare a message comprising information indicating an identity of a communication element and information indicating an identity of the communication cell selected as the target cell from, and to cause transmission of the message.

60. The apparatus according to claim 59, wherein the at least one memory and the instructions are configured to, with the at least one processor, cause the apparatus at least to further perform:
a receiving function configured to receive an indication of time and frequency resources reserved for the transmission of the message, wherein the time and frequency resources reserved for the transmission of the message are the same in plural communication cells of the communication network.

61. The apparatus according to claim 59, wherein the information indicating the identity of the communication element and the information indicating the identity of the target cell are coded by using a single codeword.

62. A method comprising:
selecting at least one target cell from a plurality of communication cells with which a communication element can communicate,
preparing a message comprising information indicating an identity of a communication element and information indicating an identity of the communication cell selected as the target cell, and
causing transmission of the message.

63. The method according to claim 62, further comprising:
receiving an indication of time and frequency resources reserved for the transmission of the message, wherein the time and frequency resources reserved for the transmission of the message are the same in plural communication cells of the communication network.

64. The method according to claim 62, wherein the information indicating the identity of the communication element identified in the message and the information indicating the identity of the target cell are coded by using a single codeword.

65. A computer program product for a computer, comprising software code portions for performing the steps of claim 53 when said product is run on the computer.

66. A computer program product for a computer, comprising software code portions for performing the steps of claim 62 when said product is run on the computer.
